(19) United States
(12) Patent Application Publication
(10) Pub. No.: US 2020/0336194 A1
(43) Pub. Date: Oct. 22, 2020

(54) JOINT BEAM REPORTING FOR WIRELESS NETWORKS

(71) Applicant: NOKIA TECHNOLOGIES OY, Espoo (FI)

(72) Inventors: Juha Karjalainen, Oulu (FI); Sami Hakola, Kempele (FI); Mihai Enescu, Espoo (FI); Timo Koskela, Oulu (FI); Jorma Kaikkonen, Oulu (FI)

(21) Appl. No.: 16/761,788

(22) PCT Filed: Nov. 9, 2018
(86) PCT No.: PCT/FI2018/050826

§ 371 Date: May 5, 2020

Related U.S. Application Data
(60) Provisional application No. 62/591,055, filed on Nov. 27, 2017.

(51) Int. Cl. H04B 7/06; H04W 24/10; H04B 17/318; H04W 56/00; H04L 5/00; H04W 52/36

(52) U.S. Cl. CPC H04B 7/0695; H04W 24/10; H04B 17/318; H04W 52/36; H04B 7/0626; H04L 5/0051; H04W 56/001

(57) ABSTRACT

A technique includes measuring a received power for each resource of one or more resource pairs, wherein each of the one or more resource pairs includes a resource of a first resource type and a set of resources of a second resource type, wherein the resource of the first resource type is spatially quasi-colocated with the set of resources of the second resource type; selecting, based on a strongest received power, one of the one or more resource pairs for providing a joint quasi-colocation multiple-resource beam report; creating, by the user device, a joint quasi-colocation multiple-resource beam report, wherein the joint quasi-colocation multiple-resource beam report indicates a resource and a corresponding measured received power for each resource of the selected resource pair, including for a resource of the first resource type and each resource of the set of resources of the second resource type of the selected resource pair.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the Long Term Evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node B (eNBs), provide wireless access within a coverage area or cell. In LTE, mobile devices, or mobile stations are referred to as user equipments (UE). LTE has included a number of improvements or developments.

5G New Radio (NR) development is part of a continued mobile broadband evolution process to meet the requirements of 5G, similar to earlier evolution of 3G & 4G wireless networks. A goal of 5G is to provide significant improvement in wireless performance, which may include new levels of data rate, latency, reliability, and security. 5G NR may also scale to efficiently connect the massive Internet of Things (IoT), and may offer new types of mission-critical services.

### SUMMARY

According to an example implementation, a method includes measuring a received power for each resource of one or more resource pairs, wherein each of the one or more resource pairs includes a resource of a first resource type and a set of resources of a second resource type, wherein the resource of the first resource type is spatially quasi-colocated with the set of resources of the second resource type; selecting, based on a strongest received power or a strongest aggregated received power obtained by the measuring, one of the one or more resource pairs for providing a joint quasi-colocation multiple-resource beam report; creating, by the user device, a joint quasi-coloration multiple-resource beam report, wherein the joint quasi-colocation multiple-resource beam report indicates a resource and a corresponding measured received power for each resource of the selected resource pair, including for a resource of the first resource type and each resource of the set of resources of the second resource type of the selected resource pair; and controlling sending by the user device, the joint quasi-colocation multiple-resource beam report.

According to an example implementation, an apparatus includes at least one processor and at least one memory including computer instructions, when executed by the at least one processor, cause the apparatus to: measure a received power for each resource of one or more resource pairs, wherein each of the one or more resource pairs includes a resource of a first resource type and a set of resources of a second resource type, wherein the resource of the first resource type is spatially quasi-colocated with the set of resources of the second resource type; select, based on a strongest received power or a strongest aggregated received power obtained by the measuring, one of the one or more resource pairs for providing a joint quasi-colocation multiple-resource beam report; create, by the user device, a joint quasi-colocation multiple-resource beam report, wherein the joint quasi-colocation multiple-resource beam report indicates a resource and a corresponding measured received power for each resource of the selected resource pair, including for a resource of the first resource type and each resource of the set of resources of the second resource type of the selected resource pair; and control sending by the user device, the joint quasi-colocation multiple-resource beam report.

According to an example implementation, a computer program product includes a computer-readable storage medium and storing executable code that, when executed by at least one data processing apparatus, is configured to cause the at least one data processing apparatus to perform a method including: measuring a received power for each resource of one or more resource pairs, wherein each of the one or more resource pairs includes a resource of a first resource type and a set of resources of a second resource type, wherein the resource of the first resource type is spatially quasi-colocated with the set of resources of the second resource type; selecting, based on a strongest received power or a strongest aggregated received power obtained by the measuring, one of the one or more resource pairs for providing a joint quasi-colocation multiple-resource beam report; creating, by the user device, a joint quasi-colocation multiple-resource beam report, wherein the joint quasi-colocation multiple-resource beam report indicates a resource and a corresponding measured received power for each resource of the selected resource pair, including for a resource of the first resource type and each resource of the set of resources of the second resource type of the selected resource pair; and controlling sending by the user device, the joint quasi-colocation multiple-resource beam report.

According to an example implementation, an apparatus includes means for measuring a received power for each resource of one or more resource pairs, wherein each of the one or more resource pairs includes a resource of a first resource type and a set of resources of a second resource type, wherein the resource of the first resource type is spatially quasi-colocated with the set of resources of the second resource type; means for selecting, based on a strongest received power or a strongest aggregated received power obtained by the measuring, one of the one or more resource pairs for providing a joint quasi-colocation multiple-resource beam report; means for creating, by the user device, a joint quasi-colocation multiple-resource beam report, wherein the joint quasi-colocation multiple-resource beam report indicates a resource and a corresponding measured received power for each resource of the selected resource pair, including for a resource of the first resource type and each resource of the set of resources of the second resource type of the selected resource pair; and means for controlling sending by the user device, the joint quasi-colocation multiple-resource beam report.

According to an example implementation, a method includes measuring a received power for each resource of one or more resource pairs, wherein each of the one or more resource pairs includes a synchronization signal block resource and a set of channel state information-reference signal resources, wherein the synchronization signal block resource is spatially quasi-colocated with the set of channel state information-reference signal resources; selecting, based on a strongest received power or a strongest aggregated received power by the measuring, one of the one or more resource pairs for providing a joint quasi-colocation multiple-resource beam report; creating, by the user device, a joint quasi-colocation multiple-resource beam report, wherein the joint quasi-colocation multiple-resource beam report including a resource indication and a measured received power of a synchronization signal block resource of the selected resource pair, resource indications of a set of channel state information-reference signal resources of the resource pair, and information indicating a measured received power of each resource of the set of channel state information-reference signal resources of the resource pair; and controlling sending by the user device, the joint quasi-colocation multiple-resource beam report.

According to an example implementation, an apparatus includes at least one processor and at least one memory including computer instructions, when executed by the at least one processor, cause the apparatus to: measure a received power for each resource of one or more resource pairs, wherein each of the one or more resource pairs includes a synchronization signal block resource and a set of channel state information-reference signal resources, wherein the synchronization signal block resource is spatially quasi-colocated with the set of channel state information-reference signal resources; select, based on a strongest received power or a strongest aggregated received power by the measuring, one of the one or more resource pairs for providing a joint quasi-colocation multiple-resource beam report; create, by the user device, a joint quasi-colocation multiple-resource beam report, wherein the joint quasi-colocation multiple-resource beam report including a resource indication and a measured received power of a synchronization signal block resource of the selected resource pair, resource indications of a set of channel state information-reference signal resources of the resource pair, and information indicating a measured received power of each resource of the set of channel state information-reference signal resources of the resource pair; and control sending by the user device, the joint quasi-colocation multiple-resource beam report.

According to an example implementation, a computer program product includes a computer-readable storage medium and storing executable code that, when executed by at least one data processing apparatus, is configured to cause the at least one data processing apparatus to perform a method including: measuring a received power for each resource of one or more resource pairs, wherein each of the one or more resource pairs includes a synchronization signal block resource and a set of channel state information-reference signal resources, wherein the synchronization signal block resource is spatially quasi-colocated with the set of channel state information-reference signal resources; selecting, based on a strongest received power or a strongest aggregated received power by the measuring, one of the one or more resource pairs for providing a joint quasi-colocation multiple-resource beam report; creating, by the user device, a joint quasi-colocation multiple-resource beam report, wherein the joint quasi-colocation multiple-resource beam report including a resource indication and a measured received power of a synchronization signal block resource of the selected resource pair, resource indications of a set of channel state information-reference signal resources of the resource pair, and information indicating a measured received power of each resource of the set of channel state information-reference signal resources of the resource pair; and controlling sending by the user device, the joint quasi-colocation multiple-resource beam report.

According to an example implementation, an apparatus includes means for measuring a received power for each resource of one or more resource pairs, wherein each of the one or more resource pairs includes a synchronization signal block resource and a set of channel state information-reference signal resources, wherein the synchronization signal block resource is spatially quasi-colocated with the set of channel state information-reference signal resources; means for selecting, based on a strongest received power or a strongest aggregated received power by the measuring, one of the one or more resource pairs for providing a joint quasi-colocation multiple-resource beam report; means for creating, by the user device, a joint quasi-colocation multiple-resource beam report, wherein the joint quasi-colocation multiple-resource beam report including a resource indication and a measured received power of a synchronization signal block resource of the selected resource pair, resource indications of a set of channel state information-reference signal resources of the resource pair, and information indicating a measured received power of each resource of the set of channel state information-reference signal resources of the resource pair; and means for controlling sending by the user device, the joint quasi-colocation multiple-resource beam report.

According to an example implementation, a method includes controlling sending, by abase station for one or more resource pairs, quasi-colocation information indicating that a resource of a first resource type of the resource pair is spatially quasi-colocated with a set of resources of a second resource type of the resource pair; and controlling receiving, by the base station from a user device, a joint quasi-colocation multiple-resource beam report, wherein the joint quasi-colocation multiple-resource beam report indicates a resource and a corresponding received power for each resource of a selected resource pair, including for a resource of the first resource type and each resource of a set of resources of the second resource type of the selected resource pair.

According to an example implementation, an apparatus includes at least one processor and at least one memory including computer instructions, when executed by the at least one processor, cause the apparatus to: control sending, by a base station for one or more resource pairs, quasi-colocation information indicating that a resource of a first resource type of the resource pair is spatially quasi-colocated with a set of resources of a second resource type of the resource pair; and control receiving, by the base station from a user device, a joint quasi-colocation multiple-resource beam report, wherein the joint quasi-colocation multiple-resource beam report indicates a resource and a corresponding received power for each resource of a selected resource pair, including for a resource of the first resource type and each resource of a set of resources of the second resource type of the selected resource pair.

According to an example implementation, a computer program product includes a computer-readable storage medium and storing executable code that, when executed by at least one data processing apparatus, is configured to cause the at least one data processing apparatus to perform a method including: controlling sending, by a base station for one or more resource pairs, quasi-coloration information indicating that a resource of a first resource type of the resource pair is spatially quasi-colocated with a set of resources of a second resource type of the resource pair; and controlling receiving, by the base station from a user device, a joint quasi-colocation multiple-resource beam report, wherein the joint quasi-colocation multiple-resource beam report indicates a resource and a corresponding received power for each resource of a selected resource pair, including for a resource of the first resource type and each resource of a set of resources of the second resource type of the selected resource pair.

According to an example implementation, an apparatus includes means for controlling sending, by a base station for one or more resource pairs, quasi-colocation information indicating that a resource of a first resource type of the resource pair is spatially quasi-colocated with a set of resources of a second resource type of the resource pair; and means for controlling receiving, by the base station from a user device, a joint quasi-colocation multiple-resource beam report, wherein the joint quasi-colocation multiple-resource beam report indicates a resource and a corresponding received power for each resource of a selected resource pair, including for a resource of the first resource type and each resource of a set of resources of the second resource type of the selected resource pair.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a diagram illustrating shows an example of a joint quasi-colocated (QCL) SSB-CSI-RS beam report pair in spatial beam domain in spatial beam domain according to an example implementation.

FIG. 3 is a diagram illustrating shows an example of a joint quasi-colocated (QCL) SSB-CSI-RS beam report pair over multiple resource pairs in spatial beam domain according to an example implementation.

FIG. 4 is a diagram illustrating operation of a user device according to an example implementation.

FIG. 5 is a diagram illustrating operation of a user device according to an example implementation.

FIG. 6 is a flow chart illustrating operation of a base station according to an example implementation.

FIG. 7 is a block diagram of a node or wireless station (e.g., base station/access point or mobile station/user device) according to an example implementation.

### DETAILED DESCRIPTION

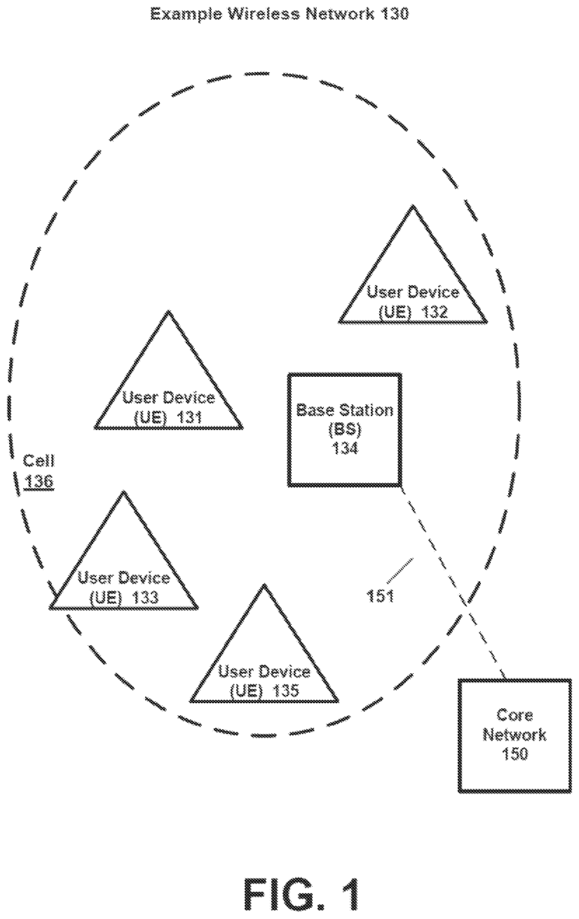

FIG. 1 is a block diagram of a wireless network 130 according to an example implementation. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB, or a network node. At least part of the functionalities of an access point (AP), base station (BS) or (e)Node B (eNB) may be also be carried out by any node, server or host which may be operably coupled to a transceiver, such as a remote radio head. BS (or AP) 134 provides wireless coverage within a cell 136, including to user devices 131, 132, 133 and 135. Although only four user devices are shown as being connected or attached to BS 134, any number of user devices may be provided. BS 134 is also connected to a core network 150 via a 51 interface 151. This is merely one simple example of a wireless network, and others may be used.

A user device (user terminal, user equipment (UE) or mobile station) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

In addition, by way of illustrative example, the various example implementations or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), wireless relaying including self-backhauling, D2D (device-to-device) communications, and ultra-reliable and low-latency communications (URLLC). Scenarios may cover both traditional licensed band operation as well as unlicensed band operation.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability).

The various example implementations may be applied to a wide variety of wireless technologies or wireless networks, such as LTE, LTE-A, 5G, cmWave, and/or mmWave band networks, IoT, MTC, eMTC, eMBB, URLLC, etc., or any other wireless network or wireless technology. These example networks, technologies or data service types are provided only as illustrative examples.

The current architecture in LTE networks is fully distributed in the radio and fully centralized in the core network. Relatively low latency may require that the content be brought close to the radio which leads to local break-out and multi-access edge computing (MEC). According to an example implementation, 5G may use edge cloud and local cloud architecture. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services and augmented reality. In an example implementation, in radio communications, using edge cloud may mean that node operations may be carried out, at least partly, in a server, host or node operationally coupled to a remote radio head or base station comprising radio parts (central unit, and/or distributed unit). Also, in an example implementation, node operations may be distributed among a plurality of servers, nodes or hosts. It should also be understood that the distribution of labor between core network operations and base station operations may differ from that of the LTE or even be non-existent. Some other technology advancements may be used include Software-Defined Networking (SDN), Big Data, and all-IP, which may change the way networks are being constructed and managed.

According to an example implementation, beamforming may be used by a receiver and/or transmitter to improve wireless communication performance. In an example implementation, at a transmitter, a set of transmit beam weights (e.g., with each beam weight including a gain and/or phase) may be applied to a set of antennas at or during transmission of a signal to transmit the signal on a specific transmit beam. Also, at a receiver, a set of receive beam weights may be applied to an array of antennas to receive the signal via a receive beam. Thus, in beamforming, each transmitter/receiver signal may be multiplied by a set of complex weights that adjust the phase and/or magnitude of the signal to and from each antenna array. By applying the beam weight to an array of antennas, this causes the output from the array of antennas to form a transmit beam at the transmitter, and to form a receive beam at the receiver, in the desired direction, and decreases the signal output in other directions.

According to an example implementation, a BS (e.g., a 5G BS, which may be referred to as a gNB, or other BS) may transmit a synchronization signal block (SS block, or SSB), which may be received by one or more UEs/user devices. A SSB may include synchronization signal to allow the UE to synchronize to a BS, and perform random access to the BS. In an example implementation, a SS block may include, e.g., one or more or even all of: primary synchronization signals (PSS), secondary synchronization signals (SSS), a physical broadcast control channel (PBCH), and demodulation reference signals (DMRS). By way of illustrative example, the PSS and SSS may allow a UE to obtain initial system acquisition, e.g., which may include obtaining initial time synchronization (e.g., including symbol and frame timing), initial frequency synchronization, and cell acquisition (e.g., including obtaining the physical cell ID for the cell). Also, a UE may use DMRS and PBCH to determine slot and frame timing.

A base station (BS) may sweep through a group of SSB beams associated with resources, by applying a different beam each time period, and transmitting a SSB via each transmit beam. This may allow SSBs to be transmitted across a full area of a cell. A UE may measure a signal parameter, such as a reference signal received power (RSRP) of one or more received SSBs, and then may send a random access preamble associated with a best or strongest SSB (where each SSB is associated with composite beam or transmitted via a specific transmit beam). For example, the SSBs may be transmitted via a set of relatively wide beams and resources therein, e.g., to be used for UE synchronization and initial access.

In addition, a BS may also transmit channel state information-reference signals (CSI-RSs) via each of a plurality of beams associated with resources. In an example implementation, the CSI-RSs may be transmitted via a set of transmit beams that may be narrower than the beams used to transmit SSBs. The CSI-RS signals may, for example, allow a UE to measure and select a narrower beam (or transmit/receive beam pair) that may be used for communication with the BS. According to an example implementation, after performing synchronization and establishing a connection to a BS based on a received SSB(s), a UE may then receive channel state information-reference signals (CSI-RSs) from the BS. A UE may measure a signal parameter, such as a RSRP, of a CSI-RS received via one or more beams associated with resources, and may select a best or strongest (highest measured received power) of one of the CSI-RSs (thus, selecting a best or strongest CSI-RS resource and associated beam).

Therefore, each SSB may be associated with a beam (or spatial domain filter) and may be transmitted via a time-frequency resource. Also, each CSI-RS is associated with a beam (or spatial domain filter) and is transmitted via a time-frequency resource.

In an example implementation, a UE may send a beam report to identify a SSB resource indicator (e.g., SSB resource index, which may be referred to as SSBRI) to identify the time-frequency resource(s) (which are mapped or assigned to associated beam(s)) and measured received power (or other signal parameter) for a best or strongest measured SSB(s). A UE may also send a beam report to identify a CSI-RS resource indicator/index (CRI) to identify the time-frequency resource(s) (which mare mapped to associated beam(s)) and measured received power(RSRP) (or other signal parameter) for a best or strongest measured CSI-RS(s). Each CSI-RS resource may be mapped to or assigned to a beam, e.g., a specific beam that is used to transmit each CSI-RS signal.

In an illustrative example implementation, a SSB resource (e.g., time-frequency resource associated with a beam used to transmit a SSB) may be spatially quasi-colocated (QCLed) with a set of (one or more) CSI-RSI resources (e.g., time-frequency resources and associated beams used to transmit the CSI-RS signals). Spatially quasi-colocation (spatially QCL) refers to two resources (including associated beams) that share same or similar spatial properties between the resources. For example, if two resources (two time-frequency resources and associated beams) are spatially quasi-colocated (QCL), then this means that the two resources/beams share same or similar spatial properties between these two resources. In an illustrative example implementation, two different signals (e.g., a SSB resource and a CSI-RS) may be transmitted over two resources via two beams that are at least partially spatially overlapping. For example, a SSB may be transmitted via a wide beam that at least partially overlaps with a set of narrower beams used to transmit a set of CSI-RS signals. In such an illustrative example, the SSB resource/beam may be quasi-colocated with the set of CSI-RS resources/beams. In addition, there may be other QCL parameters, such as, e.g., time, delay spread, Doppler shift/spread, average power, and the like.

According to an example implementation, a UE may send separate beam reports to separately report resources and measured power for SSB resource(s) and CSI-RI resource(s). For example, a first beam report may be used to report a best/strongest SSB resource (and thus, identify a best/strongest beam used to transmit the SSB). A second beam report may be used to report a best/strongest set of CSI-RS resources (and thus, identify a set of best beams that were used to transmit the CSI-RS signals).

However, in order to improve reporting efficiency and/or reduce reporting/signaling overhead, a UE may combine the beam reports for multiple types of resources, such as for both SSB resource(s) and CSI-RS resource(s). Thus, according to an example implementation, a UE may create and send a joint beam report for a pair of resources that are quasi-colocated. Such a joint beam report may, for example, be referred to as a joint quasi-colocation multiple-resource beam report to jointly report measured power (or other signal parameter) for two (or multiple) resources (different resource types) that are quasi-colocated. For example, in the case where the two resources (or resource types) that are being reported are a SSB resource and a set of CSI-RS resources that are QCL, the joint beam report may be referred to as a joint QCL SSB-CSI-RS beam report (or a joint QCL SSB-CSI-RS report pair).

According to an example implementation, a method may include measuring a received power (e.g., reference signal received power or RSRP) for each resource of one or more resource pairs, wherein each of the one or more resource pairs includes a resource of a first resource type (e.g., a SSB resource) and a set of resources of a second resource type (e.g., a set of CSI-RS resources), wherein the resource of the first resource type is spatially quasi-colocated with the set of resources of the second resource type. For example, a UE may receive colocation information that may identify resources for one or more resource pairs, e.g., identifying a SSB resource and a set of CSI-RS resources of a resource pair that are spatially quasi-collocated. For example, the measured power for the pair of resources that are quasi-colocated may be reported in a joint quasi-colocation multiple-resource beam report.

The method may also include selecting, based on a strongest received power (e.g., strongest RSRP) or a strongest aggregated (e.g., strongest or highest average RSRP over the first and second types of resources of the pair) received power obtained by the measuring, one of the one or more resource pairs for providing a joint quasi-colocation multiple-resource beam report. Different selection criteria may be used for selecting the strongest or best resource pair(s) to be reported via a joint quasi-colocation multiple-resource beam report (e.g., to be reported via a joint QCL SSB-SCI-RS beam report or report pair), such as SSB RSRP, aggregated (e.g., average) CSI-RS RSRP of each pair, or an aggregated (or average) RSRP of the SSB and CSI-RS resources of each pair.

As noted above, different selection criteria may be used by a UE to select a resource pair(s) to be reported. In an example implementation, the selecting may include at least one of the following: 1) selecting one of the one or more resource pairs having a strongest received power of the resource of the first resource type of the resource pair (e.g., based on a strongest RSRP of the SSB resource of the resource pair); 2) selecting one of the one or more resource pairs having a strongest aggregated received power computed over the set of resources of the second resource type of the resource pair (e.g., based on a strongest aggregated (e.g., average) power computed over the set of CSI-RS resources of the resource pair); and 3) selecting one of the one or more resource pairs having a strongest aggregated received power computed over both the resource of the first resource type of the resource pair and the set of resources of the second resource type of the resource pair (e.g., based on a strongest aggregated (e.g., average) power computed over both the SSB resource and the set of CSI-RS resources of the resource pair).

The method may also include creating (or generating), by the user device, a joint quasi-colocation multiple-resource beam report, wherein the joint quasi-colocation multiple-resource beam report indicates a resource (e.g., SSBRI, CRI) and a corresponding measured received power (RSRP, quantized power value, or power offset with respect to a reference power value) for each resource of the selected resource pair, including for a resource of the first resource type (e.g., for a SSB resource) and each resource of the set of resources of the second resource type (e.g., a set of CSI-RS resources) of the selected resource pair. The method may include controlling sending by the user device, the joint quasi-colocation multiple-resource beam report to a BS or other node.

An illustrative example will be briefly described for use of the three different selection criteria to select a resource pair(s) to be reported. A UE may receive, for example, quasi-colocation information from a BS or network node indicating that a first SSB resource and a first set of CSI-RS resources of resource pair 1 are spatially QCL, and that a second SSB resource and a second set of CSI-RS resources of resource pair 2 are spatially QCL. For example, the quasi-colocation information may provide resource indicators (e.g., SSB resource indicator (SSBRI) and a set of CSI-RS resource indicators (CRIs)) for each resource pair.

The UE may measure the received power (e.g., layer 1 or PHY/physical layer RSRP (L1-RSRP)) of each resource of each of the QCL resource pairs. Thus, for example, the UE may measure the RSRP of the SSB resource and each CSI-RS resource of the set of resources, for each resource pair that are QCL. The measured RSRP of the resources of resource pair 1 and resource pair 2 may be, for example, as follows, by way of illustrative example (in this illustrative example, one SSB resource may be considered to be spatially quasi-colocated (QCLed) with a set of four SSI-RS resources):

Resource pair 1: SSB-20 (RSRP=−80 dBm), CRI-2 (RSRP=−78 dBm), CRI-5 (RSRP=−78 dBm), CRI-7 (RSRP=−54 dBm), CRI-9 (RSRP=−58 dBm).

Resource pair 2: SSB-16 (RSRP=−60 dBm), CRI-31 (RSRP=−59 dBm), CRI-21 (RSRP=−56 dBm), CRI-14 (RSRP=−48 dBm), and CRI-11 (RSRP=−55 dBm).

In this illustrative example, for each resource pair, a resource indicator (e.g., resource index) is provided to identify the resource, followed in parentheses by a L1-RSRP measured for the indicated resource, for all the resources of the resource pair. For example, SSB-20 (RSRP=−80 dBm) indicates that a SSB resource having a resource index of 80 has a measured L1-RSRP of −80 dBm. Likewise, CRI-2 (RSRP=−78 dBm) indicates that a CRI resource having a resource index of 2 has a measured L1-RSRP of −78 dBm. The resource index identifies the time-frequency resources for the resource. As noted, there is abeam associated with (e.g., used to transmit a signal for) each SSB or CSI-RS resource.

In a first illustrative example, in which a resource pair is selected based on SSB RSRP: a UE may select a resource pair(s), out of a plurality of resource pairs, based on a strongest RSRP of the SSB resource of the resource pair. Thus, a resource pair may be selected based on the RSRP of the SSB of the resource pair. In the example above, SSB-16 of resource pair 2 has a stronger RSRP (−60 dBm) than SSB-20 (−80 dBm) of resource pair 1. Thus, in this example, the UE may select resource pair 2 to be reported via a joint quasi-colocation multiple-resource beam report.

In a second illustrative example, in which a resource pair is selected based on an aggregate (e.g., average) RSRP for a set of CSI-RS resources: a UE may determine an aggregated RSRP computed or calculated over each set of CSI-RS resources, for each pair, and then select the resource pair having the strongest aggregate (e.g., strongest/highest average) RSRP for the set of CSI-RS resources. In this example, an aggregate (e.g., average) of the CSI-RS RSRP values (−78 dBm, −70 dBm, −54 dBm, −58 dBm) of resource pair 1 is determined by UE as −65 dBm. Similarly, the aggregate (e.g., average) of the CSI-RS RSRP values (−59 dBm, −56 dBm, −48 dBm, −55 dBm) of resource pair 2 is determined by the UE as −54.5 dBm, which is stronger than the aggregated measured CSI-RS power for resource pair 1 (−65 dBm). Thus, in this illustrative example, the UE may select resource pair 2 to be reported via a joint quasi-colocation multiple-resource beam report.

In a third illustrative example, in which a resource pair is selected based on an aggregate (e.g., average) RSRP computed across the SSB resource and a set of CSI-RS resources for a resource pair: a UE may determine an aggregated RSRP computed or calculated over both the SSB resource and each set of CSI-RS resources, for each pair, and then select the resource pair having the strongest aggregate (e.g., average) RSRP. In this example, an aggregate (e.g., average) of the SSB and CSI-RS RSRP power/RSRP values (−80 dBm, −78 dBm, −70 dBm, −54 dBm, −58 dBm) of resource pair 1 is determined by UE as −68 dBm. Similarly, the aggregate (e.g., average) of the SSB and CSI-RS RSRP/power values (−60 dBm, −59 dBm, −56 dBm, −48 dBm, −55 dBm) of resource pair 2 is determined by the UE as −55.4 dBm, which is stronger than the aggregated measured CSI-RS power for resource pair 1 (−68 dBm). Thus, in this illustrative example, the UE may select resource pair 2 to be reported via a joint quasi-colocation multiple-resource beam report. Different types of averaging may be performed, such as equal averaging of all resources of a resource pair (e.g., sum of RSRP of all 5 resources, divided by 5 to obtain the average), or a weighted average in which the SSB RSRP of a pair is weighted equally as the average of the set of CSI-RS RSRP values.

The same criteria and process, as illustrative examples, may also be used to select a plurality of resource pairs to be jointly reported by a UE. Although, in these illustrative examples, resource pair 2 was selected for all three different selection criteria, in at least some cases, a different resource pair(s) may be selected based on the different selection criteria.

In an example implementation, the method may further include controlling receiving, by the user device for one or more resource pairs, quasi-colocation information indicating that a resource of a first resource type of the resource pair is spatially quasi-colocated with the set of resources of the second resource type of the resource pair.

Also, the selection criteria may be signaled or communicated by a BS to the UE. For example, the method may further include: receiving, by the user device, an indication of a selection criteria to be used in the selecting, as one of the following selection criteria: a strongest received power of the resource of the first resource type of the resource pair; a strongest aggregated received power computed over the set of resources of the second resource type of the resource pair; and a strongest aggregated received power computed over both the resource of the first resource type of the resource pair and the set of resources of the second resource type of the resource pair.

According to an example implementation, the first resource type may include a synchronization signal block resource, and the second resource type may include a channel state information-reference signal resource.

The method may further include controlling receiving, by the user device for one or more resource pairs, quasi-colocation information indicating that a synchronization signal block resource of the resource pair is spatially quasi-colocated with a set of channel state information-reference signal resources of the resource pair, the quasi-colocation information including a resource indication of the synchronization signal block resource of the resource pair and resource indications of the set of channel state information-reference signal resources of the resource pair.

According to an example implementation, the creating may include: creating, by the user device for the selected resource pair, a joint quasi-colocation multiple-resource beam report that includes a resource indication of a synchronization signal block of the resource pair, information indicating a measured received power of the synchronization signal block resource of the resource pair, resource indications of a set of channel state information-reference signal resources of the resource pair, and information indicating a measured received power of each resource of the set of channel state information-reference signal resources of the resource pair.

According to various example implementations, different example formats may be used to communicate the measured received power (e.g., RSRP) values for the reported resources. In one example implementation, a quantized power value (e.g., quantized RSRP) value may be provided for the SSB resource and for each CSI-RS resource of the resource pair in the report. In another example implementation, a differential joint quasi-colocation multiple-resource beam report may be provided, which may include a reference power value (e.g., a maximum measured received power of the resources of the pair), and a power offset for each resource with respect to the reference power value.

In an illustrative example, resource pair 1 may be reported via the joint quasi-colocation multiple-resource beam report, then the joint quasi-colocation multiple-resource beam report may include an indication of a SSB resource and indications of the CSI-RS resources that are QCLed with the SSB resource, along with power information for each of the reported SSB and CSI-RS resources. In the example described above, the resource pair 1 may include the following resources and measured received power values (by way of example): Resource pair 1: SSB-20 (RSRP=−80 dBm), CRI-2 (RSRP=−78 dBm), CRI-5 (RSRP=−78 dBm), CRI-7 (RSRP=−54 dBm), CRI-9 (RSRP=−58 dBm).

A joint quasi-colocation multiple-resource beam report may be created by, for example: determining a reference (e.g., maximum) RSRP value of the reported resources of resource pair 1, and then determining a quantized power offset for each RSRP value with respect to the reference power/RSRP value. For example, two bits may be used to indicate a power offset of four possible power offsets (0, 1, 2 and 3), with respect to the reference power/RSRP value. For example, more bits maybe used (to provide finer granularity of power offset values, and less quantization error) for power offset values, at the expense of higher signaling/reporting overhead. Thus, a power offset values of 0, 1, 2 and 3 may be used to indicate various power offsets for a resource with respect to the reference RSRP/power value. Each RSRP value of the resource pair may be mapped to a quantized power offset (e.g., mapped to 0, 1, 2 or 3) as an efficient way to indicate a RSRP of resource, with respect to an indicated reference power/RSRP value. A power offset of 0 may indicate that the power of the resource is the same as the reference value. And higher numbers (e.g., 3) of power offset values may indicate a larger (or largest range) decreased power step (or a decrease in RSRP) for the indicated resource with respect to the reference RSRP/power value. For example, for resource pair 1, the strongest RSRP is −54 dBm (CRI-7). Thus, differential RSRP/power values may be determined for each resource of resource pair 1 as follows: power offset=3 (SSB power offset),

power offset=0 (CRI-7 offset of 0, meaning CRI-7 has the reference power),

power offset=1 (CRI-9),

power offset=2 (CRI-5), and

power offset=3 (CRI-2). These 5 power offset values, therefore, indicate the (quantized) measured power or RSRP of the indicated resources, with respect to the reference power/RSRP value.

The creating (or generating) a joint quasi-colocation multiple-resource beam report may include providing resource indications and power value (e.g., power offset values) in a format to be transmitted or sent via or within the joint quasi-colocation multiple-resource beam report. For example, this may include generating two elements for the report, such as:

Element 1: −54 dBm, 3, 0, 1, 2, 3.

Element 2: 2: 20, 7, 9, 5, 2.

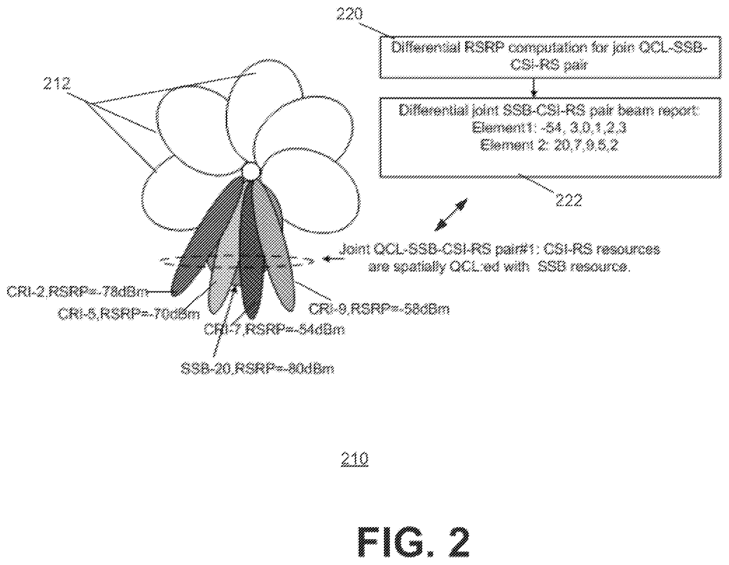

In this illustrative example of a joint quasi-colocation multiple-resource beam report, element 1 indicates the power values, while element 2 provides corresponding resource indicators (e.g., with a power value indicated in element 2 being for the corresponding resource of element 1). In this example, element 1 includes a reference (e.g., maximum) RSRP of −54 dBm, and then the power offset values of 3, 0, 1, 2, 3, which correspond (based on element 2) to: SSB-20, CRI-7, CRI-9, CRI-5, CRI-2. Thus, in this example, the two elements (element 1, element 2) may include a format of: element 1 (reference power, SSB power offset, CRI power offset, CRI power offset, CRI power offset, CRI power offset), and element 2 (SSBRI, CRI, CRI, CRI, CRI), where SSBRI is a SSB resource indication, while CRI is a CSI-RS resource indication. Thus, in this example, the order of power values in element 1 for resources is the same as the order in element 2 of the resource indications for these resources. According to an example implementation, the creating a joint quasi-colocation multiple-resource beam report may include generating or creating element 1 and element 2 (based on the measured RSRP values, and determined or mapped power offsets for each resource), which may then be sent to a BS as a joint quasi-colocation multiple-resource beam report. See FIG. 2 for further example details.

In the case where the joint quasi-colocation multiple-resource beam report provides measured received power values for resources (e.g., a SSB resource and a set of CSI-RS resources of a resource pair) for each of multiple (or a plurality of) resource pairs, the report may include either: 1) one (or a single or common) reference power value (e.g., a maximum power) indicated in the report for all reported resource pairs, where power offsets for resources of all reported resource pairs are indicated with respect to that one (or common) reference power value, or 2) a reference power value for each resource pair that is reported (e.g., a maximum power value included in the report for each resource pair), where power offsets for resources of a resource pair are indicated with respect to the reference power value for or corresponding that resource pair). Option 1) (a common reference power value for all reported resource pairs) may provide a more efficient signaling/reporting technique as compared to option 2), but at the expense of increased (or a higher) quantization error, as compared to option 2) (which uses a reference power for each resource pair that is reported).

Thus, according to an example implementation, the creating may include creating, by the user device for the selected resource pair, a differential (e.g., based on providing power offsets for each or one or more resources of the reported pair(s)) joint quasi-colocation multiple-resource beam report that indicates a reference power and a power offset, with respect to the reference power, for each resource of the selected resource pair, including a power offset for the resource of the first resource type and a power offset for each resource of the set of resources of the second resource type of the selected resource pair.

As noted above, in the case of multiple resource pairs that are reported in one report, a reference power may be indicated as a common reference power for all reported resource pairs, or a reference power may be provided or indicated in the report for each reported resource pair. Thus, according to an example implementation, the creating may include creating, by the user device a joint quasi-colocation multiple-resource beam report for the plurality of selected resource pairs, including information indicating one (e.g., a common) reference power, and a power offset for each resource of the plurality of resource pairs with respect to the reference power (e.g., in this case, a power offset is provided in the report for all resources of all reported resource pairs with respect to this one or common reference (e.g., maximum) power. And, alternatively, the creating may include creating, by the user device, a joint quasi-colocation multiple-resource beam report for the plurality of selected resource pairs, including information indicating a reference power for each resource pair of the plurality of selected resource pairs, and a power offset for each resource of the plurality of resource pairs with respect to the reference power of a corresponding resource pair (e.g., a first reference power may be provided for a first resource pair, and each resource of the first resource pair may be indicated with respect to the first reference power; and a second reference power may be provided for a second resource pair that is reported in the same report, and each resource of the second resource pair may be indicated with respect to the second reference power).

According to an example implementation, the creating may include: creating, by the user device for the selected resource pair, a joint quasi-colocation multiple-resource beam report that comprises: a first element that indicates a reference power, and a power offset for each resource of the selected resource pair with respect to the reference power; and a second element that identifies resources of the selected resource pair, including a synchronization signal block resource indicator that identifies the synchronization signal block resource of the resource pair and resource indicators that identify the set of channel state information-reference signal resources of the selected resource pair.

FIG. 2 is a diagram illustrating shows an example of a joint quasi-colocated (QCL) SSB-CSI-RS beam report pair in spatial beam domain in spatial beam domain according to an example implementation. In this example shown in FIG. 2, SSB resources are presented as “wide” beams 212 and CSI-RS resources shown as “narrow” beams. However, this is merely provided as an example, and other beam widths may be used, as the SSB and CSI-RS beams may be any beam widths. A network has higher layer configured CSI-RS resources: 2, 5, 7 and 9 to be spatially QCL:ed with SSB resource 20. Furthermore, network has configured CSI-RS and SSB to be jointly to be reported and the number of SSB resources (1) and the number of CSI-RS resources (4) to be reported as part of a resource pair. For example, the following resources and RSRP values may be communicated (e.g., using differential power offsets, with respect to a reference RSRP) via a joint quasi-colocated (QCL) SSB-CSI-RS report pair (or joint quasi-colocated (QCL) SSB-CSI-RS beam report) for resource pair 1: SSB-20 (−80 dBm), CRI-2 (−78 dBm), CRI-5 (−70 dBm), CRI-7 (−54 dBm), CRI-9 (−58 dBm).

In this example, network has configured higher layer parameter to UE to select L-strongest QCL-SSB-CSI-RS pairs as ‘SSB-only’ (selecting a resource pair based on a strongest SSB RSRP). UE has performed L1-RSRP measurements over configured SSB and CSI-RS resources. Then, configured number of reported SSBs, i.e., L=1 and CSI-RS resources, N=4, has been selected for a joint QCL SSB-CSI-RS report pair with SSB and CSI-RS resources or resource sets. CSI-RS resource indices 2, 5, 7, and 9 in conjunction with SSB resource indicator 20 and their L1-RSRP values form the joint beam report QCL-pair. As shown in FIG. 2, a creation or generation of a joint quasi-colocated (QCL) SSB-CSI-RS report pair (or beam report) may include, for example, at 220, the UE may perform differential RSRP computation (based on measured RSRP values for each resource) for joint quasi-colocated (QCL) SSB-CSI-RS report pair (or beam report), e.g., in which a 2-bit power offset value (e.g., 0, 1, 2, 3) is assigned to each of the RSRP values of the SSB and CSI-RS resources for resource pair 1, to indicate the measured power/RSRP of each resource with respect to a reference RSRP, for example. For joint beam reporting, the network has configured the number of quantization bits, n=2, for this example. As a result of this, the following quantization RSRP levels are obtained: −54, −62.66, −71.33 and −80 dBm. In this example, there are four quantization values, because there are Q=2\hat{ }n, (n=2)=4 quantization levels. The quantization levels are obtained by =(abs(max_RSRP)−abs(min_RSRP))/(Q−1), then these values can be computed as −54, −62.66, −71.33 and −80 (e.g., corresponding to power offsets of 0, 1, 2 and 3, respectively, for example). At 222, based on these values, the differential joint SSB-CSI-RS part beam report can be created or computed having two elements: element 1 (RSRP values): −54 dBm (reference power value/maximum power value), 3, 0, 1, 2, 3 (power offsets for the SSB resource and four CSI-RS resources, using the 2-bit power offset); and element 2 (resource indicators): 20 (SSBRI), 7,9,5,2 (resource indicators for the four CRIs).

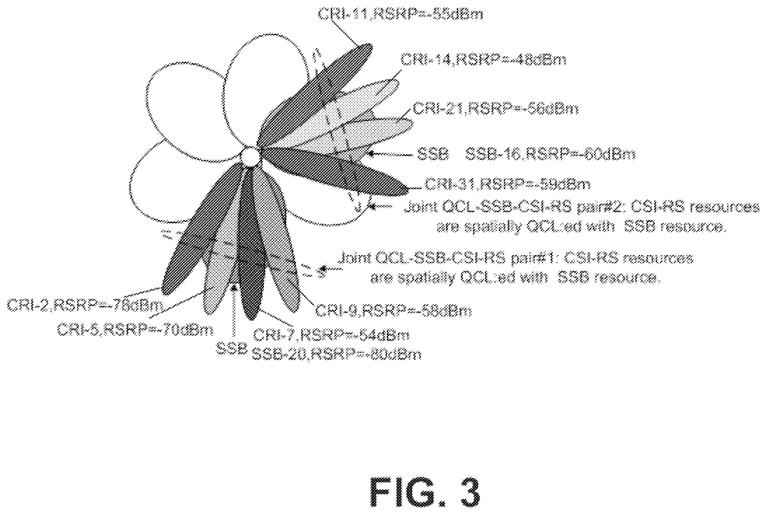

FIG. 3 is a diagram illustrating shows an example of a joint quasi-colocated (QCL) SSB-CSI-RS beam report pair over multiple resource pairs in spatial beam domain according to an example implementation. FIG. 3 presents an example of joint SSB and CSI-RS resource beam report over multiple QCL-SSB-CSI-RS pairs. A network has configured UE to select the two, L=2, strongest QCL-SSB-CSI-RS resource pairs according to SSB+CSI-RS option (e.g., selection of two resource pairs may be selected based on strongest aggregate (e.g., average) RSRP computed over SSB resource and set of CSI-RS resources). Thus, for example, after measuring RSRP values for each resource, the UE may determine (e.g., calculate) an aggregate (e.g., average) RSRP over the SSB and QCLed set of CSI-RS resources for each resource pair, and then select the two resource pairs having the highest/strongest aggregate RSRP. The results of this selection are shown in figure, e.g., in which two selected resource pairs, resource pair 1 and resource pair 2, are shown. The network has configured the number of QCL-SSB-CSI-RS pairs in the joint beam report to be two, i.e., W=2. Based on this reporting configuration, the beam report is computed jointly over joint QCL-SSB-CSI-RS pair 1 and joint QCL-SSB-CSI-RS pair 2.

Based on measured L1-RSRP values associated with CSI-RS and SSB resources, shown in the figure, the differential joint SSB-CSI-RS beam report can be computed having two elements:

1) element 1 (RSRP values): [−54,[3 1],[0, 1,1,1,1,1,2,3]], wherein −54 dBm is the reference or maximum RSRP among the two resource pairs; and, based on the order or resource indicators of element 2: the [3, 1] identifies the power offsets of the SSB for resource pair 1 and the SSB for resource pair 2; and [0, 1,1,1,1,1,2,3] in element 1 identifies the power offsets for CSI-RS resources (CRIs) indicated by element 2 (in same order indicated by element 2); and

2) element 2 (resource indicators): [[[20,16], [14,11,21,7,9,31,5,2]].

Thus, in the example shown in FIG. 3, there is one reference (or maximum) power/RSRP value for the multiple resource pairs, and then the power offsets are provided (for all resource pairs in the beam report) with respect to this one (or common) reference power. In this manner, the UE may jointly report measured power/RSRP values for a SSB resource and a set of CSI-RS resources for multiple (or a plurality of) resource pairs, e.g., using a differential format that may be more efficient that reporting each actual RSRP value.

In another example implementation, the beam report, for multiple resource pairs, may include a reference (e.g., maximum) power/RSRP value for each resource pair that is reported, and the power offsets for each resource (SSB and set of CSI-RS resources) of a resource pair are indicated in the report with respect to the corresponding reference power.

The various example implementations may include a number of technical advantages, such as one or more of:

Enables joint reporting of power/RSRP values for two types of resources that are spatially QCLed;

Enables joint reporting of power/RSRP values for a pair of resources (including SSB resource and a set of CSI-RS resources) that are spatially QCLed; Enables to obtain L1-RSRP values on CSI-RS resources that spatially QCL:ed with SSB resources without need to perform individual CSI-RS resource based reporting. As a result of this, reduced beam reporting overhead is obtained with respect to individual CSI-RS resource based beam reporting.

Based on joint SSB and CSI-RS resource based beam reporting, network is able to identity with reduced beam reporting overhead CSI-RS based “sub-level” beams and their relative RSRP difference to “anchor/wide/fat” SSB resource based TX beams.

Further example implementations will now be briefly described.

Example implementation E1: Relating to techniques that may be used to select resource pair(s) to be reported, and techniques to determine differential values (e.g., differential power offsets) for reporting: In one implementation, joint SSB and CSI-RS resource based differential L1-RSRP computation method is provided for each SSB and CSI-RS resources/resource sets that are spatially QCL:ed with each other as follows: A network configures by higher layer parameter a method that UE shall use select L-strongest (L≤K) QCL-SSB-CSI-RS pairs, where K different SSB resources configured by network. The higher layer configured parameter UE to select L-strongest resources has following options for selecting a strongest resource pair out of L pairs: There may be multiple (e.g., 3) ways to select the best/strongest resource pair to report: 1) SSB-only: UE selects L-strongest (L≤K) resource pairs in terms of measured SSB L1-RSRP values and their corresponding resource indicators/indices. 2) SSB+CSI-RS: UE selects L-strongest (L≤K) resource pairs such that the selection corresponds the L-strongest aggregated RSRP values computed over spatially QCL:ed SSB and CSI-RS resources. For example, the l-th aggregated RSRP value is computed as linear average of measured RSRP values for CSI-RS resources being spatially QCL:ed with the l-th SSB resource. Thus, for example, this may include computing an average RSRP over a SSB resource and four QCLed CRIs, and select the L strongest/highest. And, 3) CSI-RS-only: UE selects L-strongest (L≤K) resource pairs such that the selection corresponds to the L-strongest aggregated RSRP values computed over spatially QCL:ed CSI-RS resources with l-th SSB resource. Thus, in this example, a resource pair(s) may be selected for reporting based on an aggregated (e.g., average) RSRP computed over the set of CSI-RS resources for the resource pair, and by selecting the L strongest resource pairs (e.g., based on aggregated RSRP computer over the CSI-RS resources for each pair). K is total number of configured resources (QCL-SSB-CSI-RS resource pairs). Need to report L out of K resource pairs in a beam report. UE may be informed via RRC (radio resource control) message of what resources are QCLed (higher layer configuration). K corresponds the total number of configured SSB resources out of which L QCL-SSB-CSI-RS are selected.

At UE, L different resource pairs (which are QCLed) are defined. Each resource pair includes a RSRP value and a resource indicator associated with a SSB resource and N different RSRP values and resource index/set index associated with the set of CSI-RS resources for the resource pair. A network configures, N, the number of reported CSI-RS resources within a joint SSB-CSI-RS beam report.

The computation of differential RSRP (e.g., power offset) values for each resource pair may be computed by a UE as follows, by way of illustrative example:

The amount of quantization levels is defined as: Q=2ⁿ where n is the number of bits for quantization levels leading to Q−1 different power steps. Network can configure the number of quantization bits to be common for all joint beam report QCL-pairs or report QCL pair specifically (quantization bits for power offset may be defined for all resource pairs, or per each beam report for the one or more resource pairs to be reported in the beam report). Fixed power step for the l-th joint QCL-SSB-CSI-RS pair can computed as: Δₗ=(abs(max({RSRPvecₗ}))−abs(min({RSRPvecₗ})))/(Q−1)) where, l=1 . . . L, and RSRPvec includes L1-RSRP value of SSB resource and N L1-RSRP values of CSI-RS resources being QCL:ed SSB resource and max{ } and min{ } operators select the maximum and minimum values from the corresponding vectors. The operator abs { } provides absolute value of its argument. Each of RSRP value can be rounded to the closest quantization level by computing quantization RSRP levels as: Λ_{l,k}=max({RSRPvecₗ})+Δₗq, where the index q=0 . . . , Q−1 is a relative power step.

Example implementation E2: Related to techniques for reporting RSRP/power values for resources (QCL-SSB-CSI-RS resource pair), including, e.g., element 1 and element 2. In this example, the selecting of resource pair(s) and determining differential power offsets may be performed as described in implementation E1, described above. The l-th joint SSB-CSI-RS beam report, where l=1 . . . , L, may include the L1-RSRP values (or power offsets for each resource) and resource indicators as a part of the following two elements {Element1, Element 2}:

Element 1 (reported L1-RSRP values): [max_L1-RSRP_l,SSB_pow_step_1,[CSI-RS_pow_step_l-1, . . . , CSI-RS_pow_step_1-N]], where, max_L1 RSRP_l defines the maximum L1-RSRP value of the RSRPvecl, and SSB_pow_step_1 defines the l-th relative power step value for L1-RSRP based on the SSB resource out of L. The parameter CSI-RS_pow_step_l-1 defines the l-th relative power step value for L1-RSRP based on CSI-RS resource out of N. The parameter CSI-RS_pow_step_l-N defines the l-th relative power step value for L1-RSRP based on the CSI-RS resource out of N. Note: If relative power offset is 0 for SSB_pow_step_1 field, it defines that the maximum, i.e., max_L1 RSRP_l field. If relative pow_step_1 offset=0 is among (or for) SSB resource, then the SSB resource power/RSRP defines (or is) the maximum power value (or reference power value). Otherwise, CSI-RS resource defines the maximum value (e.g., a power of one of the CSI-RS resources will be the maximum or reference power value).

Element 2 (reported resource indicators): [SSB_resource_indicator_1, [CRI_l-1, . . . CRI_l-N]], where the parameter SSB_resource_indicator_1 can be either local or global SSB resource indicator/SSB index and CRL_l-1 is the l-th local or global CSI-RS resource indicator and CRI_l-1_N is the l-th local or global CSI-RS resource indicator associated with the N-th-L1-RSRP value provided as part of the element 1.

Example implementation E3. Relates to joint SSB-CSI-RS beam report for multiple resource pairs. The multiple joint QCL-SSB-CSI-RS beam report may include L1-RSRP values and resource indicators as a part of the following two elements {Element1, Element 2}:

Element 1: [[max_L1-RSRP 1,SSB_pow_step_1,[CSI-RS_pow_step_l-1, . . . , CSI-RS_pow_step_1-N]] [max_L1-RSRP_1,SSB_pow_step_1, . . . , [CSI-RS_pow_step_l-1, . . . , CSI-RS_pow_step_l-N]]], where l=2 . . . L. Element 2: [[SSB_resource_indicator_1, [CRI_1-1, . . . CRI_1-N]], . . . , [SSB_resource_indicator_L, [CRI_l-1, . . . CRI_l-N]]].

Example implementation E4: Relates to joint SSB-CSI-RS beam report for multiple resource pairs, in which the beam report includes a reference (e.g., maximum) power value per resource pair, for each reported resource pair. In this example, joint SSB and CSI-RS resource based differential L1-RSRP computation method is defined jointly over multiple (W) resource pairs. The joint SSB-CSI-RS beam report includes differential values for multiple (W) resource pairs. The parameter, W, defines the number of jointly reported resource pairs from L pairs. There is P=L/W different jointly reported pairs, where W is higher layer configured by a network. The P different joint reports are defined by organizing L pairs in descending order in terms of computed L1-RSRP metric. Then, by using this descending order W consecutive instances are used to define the p-th jointly reported pair, where p=1 . . . P. Here, P different reports are not needed to be spatially QCL:ed with each other. The computation of differential RSRP for each p-th QCL-SSB-CSI-RS set of pairs can be computed at UE as follows: Fixed power step for the p-th joint QCL-SSB-CSI-RS set of pairs can computed as: Δₚ=(abs(max({RSRPvecₚ}))−abs(min({RSRPvecₚ})))/(Q−1)) where, p=1 . . . P, and RSRPvecₚ includes L1-RSRP value of set of P different SSB resources and P times N L1-RSRP values of CSI-RS resources and max{ } and min{ } operators select the maximum and minimum values from the corresponding vectors. The operator abs { } provides absolute value of its argument. Each of RSRP value can be rounded to the closest quantization level by computing quantization RSRP levels as: Λ_{p,q}=max({RSRPvecₚ})+Δₚq, where the index q=0 . . . , Q−1 is a relative power step. P=L/W, where L defines potential SSB and CSI-RS resource pairs and W defines the number of jointly reported/computed resource pairs. Therefore, there are all together P different reports.

Example Implementation E5: Relates to joint SSB-CSI-RS beam report for multiple resource pairs, in which the beam report includes a single (or common) reference (e.g., maximum) power value for all reported resource pairs. In this case, lower signaling or reporting overhead is achieved through use of only one (a common) reference power (e.g., maximum RSRP), and the beam report may include a power offset, with respect to this common reference power, for all resources of the multiple reported resource pairs. For example, joint SSB and CSI-RS resource based differential L1-RSRP beam report over multiple, W, QCL-SSB-CSI-RS pairs. The report defines differential L1-RSRP joint set of QCL-SSB-CSI-RS pair beam report. The p-th joint set of QCL-SSB-CSI-RS pair beam report, where p=1 . . . , P, includes the L1-RSRP values and resource indicators as a part of the following two elements {Element1, Element 2}: Element 1 (reported L1-RSRP values): [max_L1-RSRP_p,[SSB_pow_step_p-1 . . . SSB_pow_step_p-WMCSI-RS_pow_step_p-1, . . . , CSI-RS_pow_step_p-WN]], where, max_L1 RSRP_p defines the maximum L1-RSRP value of the RSRPvecₚ, and SSB_pow_step_p-W defines the for the p-th joint report relative power step value associated with W-th jointly reported resource. The parameter CSI-RS_pow_step_p-1 defines the for the p-th joint report relative power step value associated with L1-RSRP based on the first CSI-RS resource among W resources. The parameter CSI-RS_pow_step_p-WN defines the p-th joint report relative power step value for L1-RSRP based on the WN-th jointly reported CSI-RS resource. Element 2 (reported resource indicators): [[SSB_resource_indicator_p-1, . . . , SSB_resource_indicator_p-W], [CRI_p−1, . . . CRI_p-WN]], where the parameter SSB_resource_indicator_p can be either local or global SSB_resource_indicator/SSB index and CRI_p-1 is the p-th local or global CSI-RS resource indicator and CRI_p-1WN is the p-th local or global CSI-RS resource indicator associated with the WN-th-L1-RSRP value provided as part of the element 2.

### Example 1

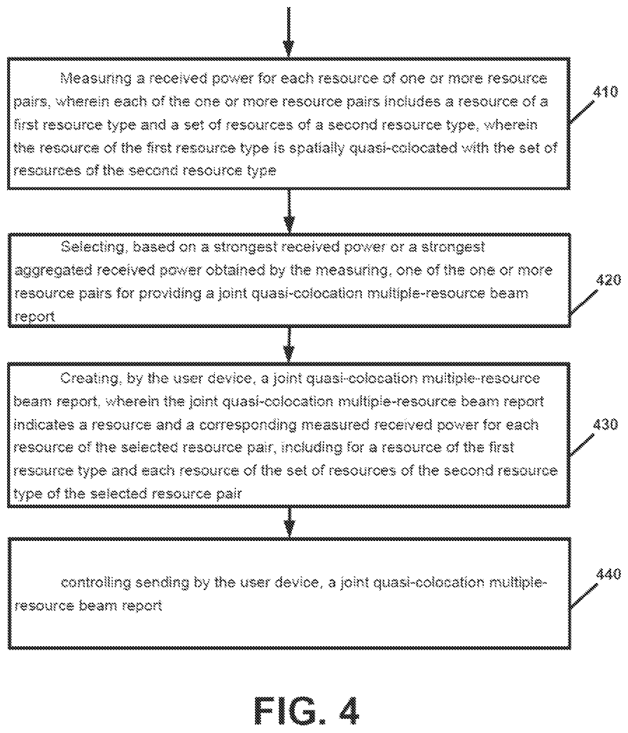

FIG. 4 is a flow chart illustrating operation of a user device according to an example implementation. Operation 410 includes measuring a received power for each resource of one or more resource pairs, wherein each of the one or more resource pairs includes a resource of a first resource type and a set of resources of a second resource type, wherein the resource of the first resource type is spatially quasi-colocated with the set of resources of the second resource type. Operation 420 includes selecting, based on a strongest received power or a strongest aggregated received power obtained by the measuring, one of the one or more resource pairs for providing a joint quasi-colocation multiple-resource beam report. Operation 430 includes creating, by the user device, a joint quasi-colocation multiple-resource beam report, wherein the joint quasi-colocation multiple-resource beam report indicates a resource and a corresponding measured received power for each resource of the selected resource pair, including for a resource of the first resource type and each resource of the set of resources of the second resource type of the selected resource pair. And, operation 40 includes controlling sending by the user device, a joint quasi-colocation multiple-resource beam report.

### Example 2

According to an example implementation of example 1, wherein: the first resource type comprises a synchronization signal block resource; and the second resource type comprises a channel state information-reference signal resource.

### Example 3

According to an example implementation of any of examples 1-2, and further comprising: controlling receiving, by the user device for one or more resource pairs, quasi-colocation information indicating that a resource of a first resource type of the resource pair is spatially quasi-colocated with the set of resources of the second resource type of the resource pair.

### Example 4

According to an example implementation of any of examples 1-3, and further comprising: controlling receiving, by the user device for one or more resource pairs, quasi-colocation information indicating that a synchronization signal block resource of the resource pair is spatially quasi-colocated with a set of channel state information-reference signal resources of the resource pair, the quasi-colocation information including a resource indication of the synchronization signal block resource of the resource pair and resource indications of the set of channel state information-reference signal resources of the resource pair.

### Example 5

According to an example implementation of any of examples 1-4, wherein: the first resource type comprises a synchronization signal block resource; and the second resource type comprises a channel state information-reference signal resource; and wherein the creating comprises: creating, by the user device for the selected resource pair, a joint quasi-colocation multiple-resource beam report that includes a resource indication of a synchronization signal block of the resource pair, information indicating a measured received power of the synchronization signal block resource of the resource pair, resource indications of a set of channel state information-reference signal resources of the resource pair, and information indicating a measured received power of each resource of the set of channel state information-reference signal resources of the resource pair.

### Example 6

According to an example implementation of any of examples 1-5, wherein the selecting comprises at least one of the following: selecting one of the one or more resource pairs having a strongest received power of the resource of the first resource type of the resource pair; selecting one of the one or more resource pairs having a strongest aggregated received power computed over the set of resources of the second resource type of the resource pair; and selecting one of the one or more resource pairs having a strongest aggregated received power computed over both the resource of the first resource type of the resource pair and the set of resources of the second resource type of the resource pair.

### Example 7

According to an example implementation of any of examples 1-6, and further comprising: receiving, by the user device, an indication of a selection criteria to be used in the selecting, as one of the following selection criteria: a strongest received power of the resource of the first resource type of the resource pair; a strongest aggregated received power computed over the set of resources of the second resource type of the resource pair; and a strongest aggregated received power computed over both the resource of the first resource type of the resource pair and the set of resources of the second resource type of the resource pair.

### Example 8

According to an example implementation of any of examples 1-7, wherein: the first resource type comprises a synchronization signal block resource; and the second resource type comprises a channel state information-reference signal resource; and wherein the selecting comprises at least one of the following: selecting one of the one or more resource pairs having a strongest received power of the synchronization signal block resource of the resource pair; selecting one of the one or more resource pairs having a strongest aggregated received power computed over the set of channel state information-reference signal resources of the resource pair; and selecting one of the one or more resource pairs having a strongest aggregated received power computed over both the synchronization signal block resource of the resource pair and the set of channel state information-reference signal resources of the resource pair.

Example 9 According to an example implementation of any of examples 1-8 wherein the creating comprises: creating, by the user device for the selected resource pair, a joint quasi-colocation multiple-resource beam report that indicates a reference power and a power offset, with respect to the reference power, for each resource of the selected resource pair, including a power offset for the resource of the first resource type and a power offset for each resource of the set of resources of the second resource type of the selected resource pair.

### Example 10

According to an example implementation of any of examples 1-9, wherein the reference power comprises a maximum power of the resources of the resource pair.

### Example 11

According to an example implementation of any of examples 1-10, wherein: the first resource type comprises a synchronization signal block resource; and the second resource type comprises a channel state information-reference signal resource; and wherein the creating comprises: creating, by the user device for the selected resource pair, a joint quasi-colocation multiple-resource beam report that comprises: a first element that indicates a reference power, and a power offset for each resource of the selected resource pair with respect to the reference power; and a second element that identifies resources of the selected resource pair, including a synchronization signal block resource indicator that identifies the synchronization signal block resource of the resource pair and resource indicators that identify the set of channel state information-reference signal resources of the selected resource pair.

### Example 12

According to an example implementation of any of examples 1-11, wherein the selecting comprises: selecting, based on the measuring, a plurality of the one or more resource pairs for providing a joint quasi-colocation multiple-resource beam report; wherein the creating comprises: creating, by the user device a joint quasi-colocation multiple-resource beam report for the plurality of selected resource pairs, including information indicating one reference power, and a power offset for each resource of the plurality of resource pairs with respect to the reference power.

### Example 13

According to an example implementation of any of examples 1-12, wherein the selecting comprises: selecting, based on the measuring, a plurality of the one or more resource pairs for providing a joint quasi-colocation multiple-resource beam report; wherein the creating comprises: creating, by the user device, a joint quasi-colocation multiple-resource beam report for the plurality of selected resource pairs, including information indicating a reference power for each resource pair of the plurality of selected resource pairs, and a power offset for each resource of the plurality of resource pairs with respect to the reference power of a corresponding resource pair.

### Example 14

According to an example implementation of any of examples 1-13, wherein each of the resources are associated with a beam or a spatial domain filter.

### Example 15

An apparatus comprising means for performing a method of any of examples 1-14.

### Example 16

An apparatus comprising at least one processor and at least one memory including computer instructions that, when executed by the at least one processor, cause the apparatus to perform a method of any of examples 1-14.

### Example 17

An apparatus comprising a computer program product including a non-transitory computer-readable storage medium and storing executable code that, when executed by at least one data processing apparatus, is configured to cause the at least one data processing apparatus to perform a method of any of examples 1-14.

### Example 18

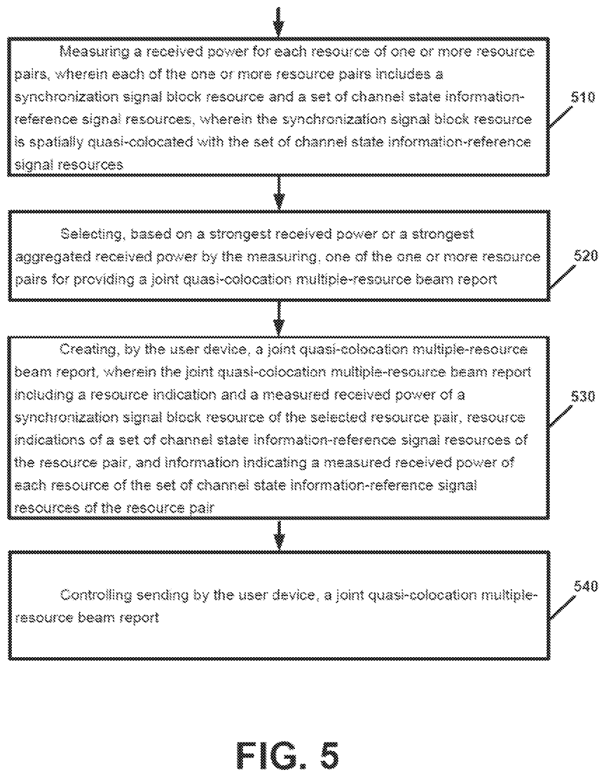

FIG. 5 is a flow chart illustrating operation of a user device according to another example implementation. Operation 510 includes measuring a received power for each resource of one or more resource pairs, wherein each of the one or more resource pairs includes a synchronization signal block resource and a set of channel state information-reference signal resources, wherein the synchronization signal block resource is spatially quasi-colocated with the set of channel state information-reference signal resources. Operation 520 includes selecting, based on a strongest received power or a strongest aggregated received power by the measuring, one of the one or more resource pairs for providing a joint quasi-colocation multiple-resource beam report. Operation 530 includes creating, by the user device, a joint quasi-colocation multiple-resource beam report, wherein the joint quasi-colocation multiple-resource beam report including a resource indication and a measured received power of a synchronization signal block resource of the selected resource pair, resource indications of a set of channel state information-reference signal resources of the resource pair, and information indicating a measured received power of each resource of the set of channel state information-reference signal resources of the resource pair. And, operation 540 includes controlling sending by the user device, a joint quasi-colocation multiple-resource beam report.

### Example 19

An apparatus comprising means for performing a method of claim 18.

### Example 20

An apparatus comprising at least one processor and at least one memory including computer instructions that, when executed by the at least one processor, cause the apparatus to perform a method of example 18.

### Example 21

An apparatus comprising a computer program product including a non-transitory computer-readable storage medium and storing executable code that, when executed by at least one data processing apparatus, is configured to cause the at least one data processing apparatus to perform a method of example 18.

### Example 22

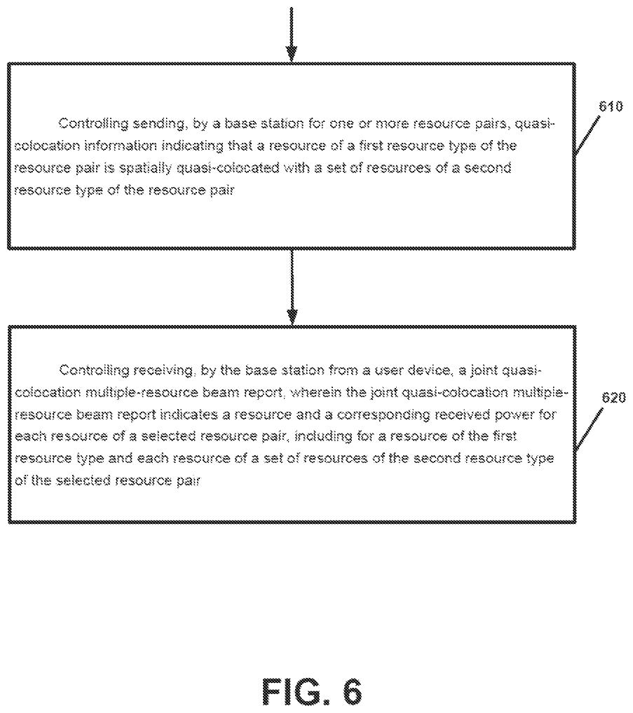

FIG. 6 is a flow chart illustrating operation of a base station according to an example implementation. Operation 610 includes controlling sending, by a base station for one or more resource pairs, quasi-colocation information indicating that a resource of a first resource type of the resource pair is spatially quasi-colocated with a set of resources of a second resource type of the resource pair. And, operation 620 includes controlling receiving, by the base station from a user device, a joint quasi-colocation multiple-resource beam report, wherein the joint quasi-coloration multiple-resource beam report indicates a resource and a corresponding received power for each resource of a selected resource pair, including for a resource of the first resource type and each resource of a set of resources of the second resource type of the selected resource pair.

### Example 23

According to an example implementation of example 22, wherein: the first resource type comprises a synchronization signal block resource; and the second resource type comprises a channel state information-reference signal resource.

### Example 24

According to an example implementation of any of examples 22-23, wherein: the first resource type comprises a synchronization signal block resource; and the second resource type comprises a channel state information-reference signal resource; and wherein the controlling sending comprises: controlling sending, by the base station for one or more resource pairs, quasi-colocation information indicating that a synchronization signal block resource of the resource pair is spatially quasi-colocated with a set of channel state information-reference signal resources of the resource pair, the quasi-colocation information indicating a resource indication of the synchronization signal block resource of the resource pair and resource indications of the set of channel state information-reference signal resources of the resource pair.

### Example 25

According to an example implementation of any of examples 22-24 and further comprising: sending, by the base station device, an indication of a selection criteria to be used in selecting a resource pair for providing a joint quasi-colocation multiple-resource beam report, as one of the following selection criteria: a strongest received power of the resource of the first resource type of the resource pair; a strongest aggregated received power computed over the set of resources of the second resource type of the resource pair; and a strongest aggregated received power computed over both the resource of the first resource type of the resource pair and the set of resources of the second resource type of the resource pair.

### Example 26

According to an example implementation of any of examples 22-25 wherein the controlling receiving comprises: controlling receiving, by the base station for a selected resource pair, a joint quasi-colocation multiple-resource beam report, wherein the joint quasi-colocation multiple-resource beam report indicates a reference power and a power offset, with respect to the reference power, for each resource of the selected resource pair, including a power offset for the resource of the first resource type and a power offset for each resource of the set of resources of the second resource type of the selected resource pair.

### Example 27

According to an example implementation of any of examples 26 wherein the reference power comprises a maximum power of the resources of the resource pair.

### Example 28

According to an example implementation of any of examples 22-27, wherein: the joint quasi-colocation multiple-resource beam report comprises: a first element that indicates a reference power, and a power offset for each resource of a selected resource pair with respect to the reference power; and a second element that identifies resources of the selected resource pair, including a synchronization signal block resource indicator that identifies the synchronization signal block resource of the resource pair and resource indicators that identify the set of channel state information-reference signal resources of the selected resource pair.

### Example 29

According to an example implementation of any of examples 22-28 wherein the joint quasi-colocation multiple-resource beam report comprises: a joint quasi-colocation multiple-resource beam report that reports information for a plurality of selected resource pairs, including information indicating one reference power, and a power offset for each resource of the plurality of resource pairs with respect to the one reference power.

### Example 30

According to an example implementation of any of examples 22-29 wherein the joint quasi-colocation multiple-resource beam report comprises: a joint quasi-colocation multiple-resource beam report that reports information for a plurality of selected resource pairs, including information indicating a reference power for each of the plurality of selected resource pairs, and a power offset for each resource of the plurality of resource pairs with respect to the reference power of a corresponding resource pair.

### Example 31

According to an example implementation of any of examples 22-30 wherein each of the resources are associated with a beam or a spatial domain filter.

### Example 32

An apparatus comprising means for performing a method of any of examples 22-31.

### Example 33

An apparatus comprising at least one processor and at least one memory including computer instructions that, when executed by the at least one processor, cause the apparatus to perform a method of any of claims 22-31.

### Example 34

An apparatus comprising a computer program product including a non-transitory computer-readable storage medium and storing executable code that, when executed by at least one data processing apparatus, is configured to cause the at least one data processing apparatus to perform a method of any of examples 22-31.

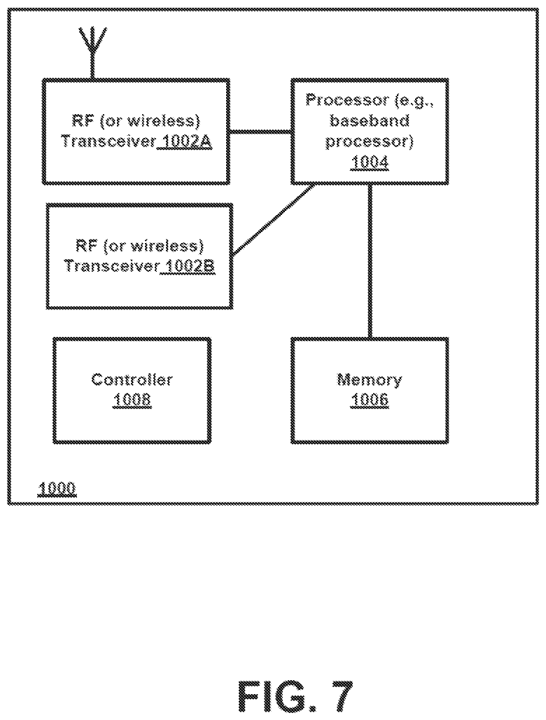

FIG. 7 is a block diagram of a wireless station (e.g., AP, BS, relay node, eNB, UE or user device) 1000 according to an example implementation. The wireless station 1000 may include, for example, one or two RF (radio frequency) or wireless transceivers 1002A, 1002B, where each wireless transceiver includes a transmitter to transmit signals and a receiver to receive signals. The wireless station also includes a processor or control unit/entity (controller) 1004 to execute instructions or software and control transmission and receptions of signals, and a memory 1006 to store data and/or instructions.

Processor 1004 may also make decisions or determinations, generate frames, packets or messages for transmission, decode received frames or messages for further processing, and other tasks or functions described herein. Processor 1004, which may be a baseband processor, for example, may generate messages, packets, frames or other signals for transmission via wireless transceiver 1002 (1002A or 1002B). Processor 1004 may control transmission of signals or messages over a wireless network, and may control the reception of signals or messages, etc., via a wireless network (e.g., after being down-converted by wireless transceiver 1002, for example). Processor 1004 may be programmable and capable of executing software or other instructions stored in memory or on other computer media to perform the various tasks and functions described above, such as one or more of the tasks or methods described above. Processor 1004 may be (or may include), for example, hardware, programmable logic, a programmable processor that executes software or firmware, and/or any combination of these. Using other terminology, processor 1004 and transceiver 1002 together may be considered as a wireless transmitter/receiver system, for example.

In addition, referring to FIG. 7, a controller (or processor) 1008 may execute software and instructions, and may provide overall control for the station 1000, and may provide control for other systems not shown in FIG. 7, such as controlling input/output devices (e.g., display, keypad), and/or may execute software for one or more applications that may be provided on wireless station 1000, such as, for example, an email program, audio/video applications, a word processor, a Voice over IP application, or other application or software.

In addition, a storage medium may be provided that includes stored instructions, which when executed by a controller or processor may result in the processor 1004, or other controller or processor, performing one or more of the functions or tasks described above.

According to another example implementation, RF or wireless transceiver(s) 1002A/1002B may receive signals or data and/or transmit or send signals or data. Processor 1004 (and possibly transceivers 1002A/1002B) may control the RF or wireless transceiver 1002A or 1002B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations may be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRI) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1. A method comprising:
measuring a received power for each resource of one or more resource pairs, wherein each of the one or more resource pairs includes a resource of a first resource type and a set of resources of a second resource type, wherein the resource of the first resource type is spatially quasi-colocated with the set of resources of the second resource type;
selecting, based on a strongest received power or a strongest aggregated received power obtained by the measuring, one of the one or more resource pairs for providing a joint quasi-colocation multiple-resource beam report;
creating, by the user device, a joint quasi-colocation multiple-resource beam report, wherein the joint quasi-colocation multiple-resource beam report indicates a resource and a corresponding measured received power for each resource of the selected resource pair, including for a resource of the first resource type and each resource of the set of resources of the second resource type of the selected resource pair; and
controlling sending by the user device, the joint quasi-colocation multiple-resource beam report.

2. The method of claim 1 wherein:
the first resource type comprises a synchronization signal block resource; and
the second resource type comprises a channel state information-reference signal resource.

3. The method of claim 1 and further comprising:
controlling receiving, by the user device for one or more resource pairs, quasi-colocation information indicating that a resource of a first resource type of the resource pair is spatially quasi-colocated with the set of resources of the second resource type of the resource pair.

4. The method of claim 1 and further comprising:
controlling receiving, by the user device for one or more resource pairs, quasi-colocation information indicating that a synchronization signal block resource of the resource pair is spatially quasi-colocated with a set of channel state information-reference signal resources of the resource pair, the quasi-colocation information including a resource indication of the synchronization signal block resource of the resource pair and resource indications of the set of channel state information-reference signal resources of the resource pair.

5. The method of claim 1 wherein:
the first resource type comprises a synchronization signal block resource; and
the second resource type comprises a channel state information-reference signal resource; and
wherein the creating comprises:
creating, by the user device for the selected resource pair, a joint quasi-colocation multiple-resource beam report that includes a resource indication of a synchronization signal block of the resource pair, information indicating a measured received power of the synchronization signal block resource of the resource pair, resource indications of a set of channel state information-reference signal resources of the resource pair, and information indicating a measured received power of each resource of the set of channel state information-reference signal resources of the resource pair.

6. The method of claim 1 wherein the selecting comprises at least one of the following:
selecting one of the one or more resource pairs having a strongest received power of the resource of the first resource type of the resource pair;
selecting one of the one or more resource pairs having a strongest aggregated received power computed over the set of resources of the second resource type of the resource pair; and
selecting one of the one or more resource pairs having a strongest aggregated received power computed over both the resource of the first resource type of the resource pair and the set of resources of the second resource type of the resource pair.

7. The method of claim 1 and further comprising:
receiving, by the user device, an indication of a selection criteria to be used in the selecting, as one of the following selection criteria:
a strongest received power of the resource of the first resource type of the resource pair;
a strongest aggregated received power computed over the set of resources of the second resource type of the resource pair; and
a strongest aggregated received power computed over both the resource of the first resource type of the resource pair and the set of resources of the second resource type of the resource pair.

8. The method of claim 1 wherein:
the first resource type comprises a synchronization signal block resource; and
the second resource type comprises a channel state information-reference signal resource; and
wherein the selecting comprises at least one of the following:
selecting one of the one or more resource pairs having a strongest received power of the synchronization signal block resource of the resource pair;
selecting one of the one or more resource pairs having a strongest aggregated received power computed over the set of channel state information-reference signal resources of the resource pair; and
selecting one of the one or more resource pairs having a strongest aggregated received power computed over both the synchronization signal block resource of the resource pair and the set of channel state information-reference signal resources of the resource pair.

9. The method of claim 1 wherein the creating comprises:
creating, by the user device for the selected resource pair, a joint quasi-colocation multiple-resource beam report that indicates a reference power and a power offset, with respect to the reference power, for each resource of the selected resource pair, including a power offset for the resource of the first resource type and a power offset for each resource of the set of resources of the second resource type of the selected resource pair.

10. The method of claim 9 wherein the reference power comprises a maximum power of the resources of the resource pair.

11. The method of claim 1, wherein:
the first resource type comprises a synchronization signal block resource; and
the second resource type comprises a channel state information-reference signal resource; and
wherein the creating comprises:
creating, by the user device for the selected resource pair, a joint quasi-colocation multiple-resource beam report that comprises:
a first element that indicates a reference power, and a power offset for each resource of the selected resource pair with respect to the reference power; and
a second element that identifies resources of the selected resource pair, including a synchronization signal block resource indicator that identifies the synchronization signal block resource of the resource pair and resource indicators that identify the set of channel state information-reference signal resources of the selected resource pair.

12. The method of claim 1 wherein the selecting comprises:
selecting, based on the measuring, a plurality of the one or more resource pairs for providing a joint quasi-colocation multiple-resource beam report;
wherein the creating comprises:
creating, by the user device a joint quasi-colocation multiple-resource beam report for the plurality of selected resource pairs, including information indicating one reference power, and a power offset for each resource of the plurality of resource pairs with respect to the reference power.

13. The method of claim 1 wherein the selecting comprises:
selecting, based on the measuring, a plurality of the one or more resource pairs for providing a joint quasi-colocation multiple-resource beam report;
wherein the creating comprises:
creating, by the user device, a joint quasi-colocation multiple-resource beam report for the plurality of selected resource pairs, including information indicating a reference power for each resource pair of the plurality of selected resource pairs, and a power offset for each resource of the plurality of resource pairs with respect to the reference power of a corresponding resource pair.

14. The method of claim 1 wherein each of the resources are associated with a beam or a spatial domain filter.

15. (canceled)

16. An apparatus comprising at least one processor and at least one memory including computer instructions that, when executed by the at least one processor, cause the apparatus to perform a method of claim 1.

17. An apparatus comprising a computer program product including a non-transitory computer-readable storage medium and storing executable code that, when executed by at least one data processing apparatus, is configured to cause the at least one data processing apparatus to perform a method of claim 1.

18. A method comprising:
measuring a received power for each resource of one or more resource pairs, wherein each of the one or more resource pairs includes a synchronization signal block resource and a set of channel state information-reference signal resources, wherein the synchronization signal block resource is spatially quasi-colocated with the set of channel state information-reference signal resources;
selecting, based on a strongest received power or a strongest aggregated received power by the measuring, one of the one or more resource pairs for providing a joint quasi-colocation multiple-resource beam report;
creating, by the user device, a joint quasi-colocation multiple-resource beam report, wherein the joint quasi-colocation multiple-resource beam report including a resource indication and a measured received power of a synchronization signal block resource of the selected resource pair, resource indications of a set of channel state information-reference signal resources of the resource pair, and information indicating a measured received power of each resource of the set of channel state information-reference signal resources of the resource pair; and
controlling sending by the user device, the joint quasi-colocation multiple-resource beam report.

19. (canceled)

20. An apparatus comprising at least one processor and at least one memory including computer instructions that, when executed by the at least one processor, cause the apparatus to perform a method of claim 18.

21. An apparatus comprising a computer program product including a non-transitory computer-readable storage medium and storing executable code that, when executed by at least one data processing apparatus, is configured to cause the at least one data processing apparatus to perform a method of claim 18.

22. A method comprising:
controlling sending, by a base station for one or more resource pairs, quasi-colocation information indicating that a resource of a first resource type of the resource pair is spatially quasi-colocated with a set of resources of a second resource type of the resource pair; and
controlling receiving, by the base station from a user device, a joint quasi-colocation multiple-resource beam report, wherein the joint quasi-colocation multiple-resource beam report indicates a resource and a corresponding received power for each resource of a selected resource pair, including for a resource of the first resource type and each resource of a set of resources of the second resource type of the selected resource pair.

23. The method of claim 22 wherein:
the first resource type comprises a synchronization signal block resource; and
the second resource type comprises a channel state information-reference signal resource.

24. The method of claim 22 wherein:
the first resource type comprises a synchronization signal block resource; and
the second resource type comprises a channel state information-reference signal resource; and
wherein the controlling sending comprises:
controlling sending, by the base station for one or more resource pairs, quasi-colocation information indicating that a synchronization signal block resource of the resource pair is spatially quasi-colocated with a set of channel state information-reference signal resources of the resource pair, the quasi-colocation information indicating a resource indication of the synchronization signal block resource of the resource pair and resource indications of the set of channel state information-reference signal resources of the resource pair.

25. The method of claim 22 and further comprising:
sending, by the base station device, an indication of a selection criteria to be used in selecting a resource pair for providing a joint quasi-colocation multiple-resource beam report, as one of the following selection criteria:
a strongest received power of the resource of the first resource type of the resource pair;
a strongest aggregated received power computed over the set of resources of the second resource type of the resource pair; and
a strongest aggregated received power computed over both the resource of the first resource type of the resource pair and the set of resources of the second resource type of the resource pair.

26. The method of claim 22 wherein the controlling receiving comprises:
controlling receiving, by the base station for a selected resource pair, a joint quasi-colocation multiple-resource beam report, wherein the joint quasi-colocation multiple-resource beam report indicates a reference power and a power offset, with respect to the reference power, for each resource of the selected resource pair, including a power offset for the resource of the first resource type and a power offset for each resource of the set of resources of the second resource type of the selected resource pair.

27. The method of claim 26 wherein the reference power comprises a maximum power of the resources of the resource pair.

28. The method of claim 22, wherein:
the joint quasi-colocation multiple-resource beam report comprises:
a first element that indicates a reference power, and a power offset for each resource of a selected resource pair with respect to the reference power; and
a second element that identifies resources of the selected resource pair, including a synchronization signal block resource indicator that identifies the synchronization signal block resource of the resource pair and resource indicators that identify the set of channel state information-reference signal resources of the selected resource pair.

29. The method of claim 22 wherein the joint quasi-colocation multiple-resource beam report comprises:
a joint quasi-colocation multiple-resource beam report that reports information for a plurality of selected resource pairs, including information indicating one reference power, and a power offset for each resource of the plurality of resource pairs with respect to the one reference power.

30. The method of claim 22 wherein the joint quasi-colocation multiple-resource beam report comprises:
a joint quasi-colocation multiple-resource beam report that reports information for a plurality of selected resource pairs, including information indicating a reference power for each of the plurality of selected resource pairs, and a power offset for each resource of the plurality of resource pairs with respect to the reference power of a corresponding resource pair.

31. The method of claim 22 wherein each of the resources are associated with a beam or a spatial domain filter.

32. (canceled)

33. An apparatus comprising at least one processor and at least one memory including computer instructions that, when executed by the at least one processor, cause the apparatus to perform a method of claim 22.

34. An apparatus comprising a computer program product including a non-transitory computer-readable storage medium and storing executable code that, when executed by at least one data processing apparatus, is configured to cause the at least one data processing apparatus to perform a method of claim 22.
